(19) United States
(12) Patent Application Publication
(10) Pub. No.: US 2022/0051174 A1
(43) Pub. Date: Feb. 17, 2022

(54) DELIVERY SYSTEM, DELIVERY MANAGEMENT APPARATUS, TERMINAL APPARATUS, DELIVERY METHOD, AND COMPUTER READABLE RECORDING MEDIUM

(71) Applicant: NEC Corporation, Minato-ku, Tokyo (JP)

(72) Inventors: Yohdai SHIBOSAWA, Tokyo (JP); Nobuyuki MINAGAWA, Tokyo (JP)

(73) Assignee: NEC Corporation, Minato-ku, Tokyo (JP)

(21) Appl. No.: 17/435,755

(22) PCT Filed: Feb. 12, 2020
(86) PCT No.: PCT/JP2020/005348

§ 371 Date: Sep. 2, 2021

(30) Foreign Application Priority Data
Mar. 5, 2019 (JP) 2019-040051

(51) Int. Cl. G06Q 10/08

(52) U.S. Cl. CPC G06Q 10/083

(57) ABSTRACT

A delivery system 10 includes a delivery worker terminal 20 used by a package delivery worker 21, a recipient terminal 30 used by a package recipient 31, and a delivery management apparatus 40. The delivery management apparatus 40 includes: a delivery worker management unit 41 that manages the reliability of the delivery worker 21; and a package management unit 42 that: if face authentication of the delivery worker 21 is successfully performed via the delivery worker terminal 20, provides a notification of the reliability of the delivery worker 21 having succeeded in face authentication to a recipient 31 of an undelivered package via the recipient terminal 30; and if the recipient 31 having received the notification requests the delivery of the undelivered package by the delivery worker 21 via the recipient terminal 30 and face authentication of the recipient 31 is successfully performed, permits the undelivered package to be handed over to the delivery worker 21 at a delivery station 50.

### TECHNICAL FIELD

The present invention relates to a delivery system, a delivery management apparatus, a terminal apparatus, and a delivery method for delivering packages, and further relates to a computer readable recording medium that includes recorded thereon a program for realizing the delivery system, the delivery management apparatus, the terminal apparatus, and the delivery method.

### BACKGROUND ART

In recent years, due to the development of Internet mail order, the number of delivered packages is increasing explosively. Consequently, there is a shortage of delivery workers in companies providing delivery services. Furthermore, as a package needs to be redelivered when the recipient is away, the shortage of delivery workers is accelerated even more also by the number of packages that need to be redelivered.

In view of such problems, Patent Document 1 discloses a system for reducing the number of redelivered packages, for example. Specifically, in the system disclosed in Patent Document 1, position information of the current location of a recipient of a package is received from a terminal apparatus used by the recipient, and the received position information is transmitted to a terminal apparatus installed in a vehicle used by a delivery company delivering the package. Thus, a delivery worker working for the delivery company can deliver the package to the recipient without having to redeliver the package, even if the recipient has moved from the initially-designated delivery place (home, etc.) of the package and is away.

### LIST OF RELATED ART DOCUMENTS

### Patent Document

Patent Document 1: Japanese Patent Laid-Open Publication No. 2003-85247

### SUMMARY OF INVENTION

### Problems to be Solved by the Invention

In such a manner, the number of redelivered packages can be reduced according to the above-described system disclosed in Patent Document 1. However, even with the above-described system disclosed in Patent Document 1, it is difficult to overcome the fundamental problem of the shortage of delivery workers. Thus, measures to be taken if the number of packages increases to more than the current number of packages are being sought for.

An example object of the invention is to provide a delivery system, a delivery management apparatus, a terminal apparatus, a delivery method, and a computer readable recording medium that can overcome the above-described problem and can overcome the shortage of delivery workers in delivery services.

### Means for Solving the Problems

In order to achieve the above-described object, a delivery system according to an example aspect of the invention includes a first terminal apparatus used by a package delivery worker, a second terminal apparatus used by a package recipient, and a delivery management apparatus, wherein

the delivery management apparatus includes:

a delivery worker management unit configured to manage the reliability of the delivery worker; and

a package management unit configured to: if face authentication of the delivery worker is successfully performed via the first terminal apparatus, provide a notification of the reliability of the delivery worker having succeeded in face authentication to a recipient of an undelivered package via the second terminal apparatus; and

if the recipient having received the notification requests the delivery of the undelivered package by the delivery worker via the second terminal apparatus and face authentication of the recipient is successfully performed, permit the undelivered package to be handed over to the delivery worker at a delivery station.

In order to achieve the above-described object, a delivery management apparatus according to an example aspect of the invention is an apparatus for managing the delivery of packages, including:

a delivery worker management unit configured to manage the reliability of a package delivery worker; and

a package management unit configured to: if face authentication of the delivery worker is successfully performed via a first terminal apparatus used by the delivery worker, provide a notification of the reliability of the delivery worker having succeeded in face authentication to a recipient of an undelivered package via a second terminal apparatus used by the recipient; and

if the recipient having received the notification requests the delivery of the undelivered package by the delivery worker via the second terminal apparatus and face authentication of the recipient is successfully performed, permit the undelivered package to be handed over to the delivery worker at a delivery station.

In order to achieve the above-described object, a terminal apparatus according to an example aspect of the invention is a terminal apparatus that performs data communication with a delivery management apparatus that manages the delivery of packages, the terminal apparatus including:

an imaging unit configured to take an image of a subject and output image data of the subject;

a position information acquisition unit configured to acquire position information of the terminal apparatus; and

a data processing unit, wherein

in response to instructions from the delivery management apparatus, the data processing unit transmits the image data output from the imaging unit and the position information acquired by the position information acquisition unit to the delivery management apparatus.

In addition, in order to achieve the above-described object, a delivery method according to an example aspect of the invention is a delivery method in which a first terminal apparatus used by a package delivery worker, a second terminal apparatus used by a package recipient, and a delivery management apparatus are used, the delivery method including

the following steps carried out by the delivery management apparatus:

a management step of managing the reliability of the delivery worker;

a notification step of, if face authentication of the delivery worker is successfully performed via the first terminal apparatus, providing a notification of the reliability of the delivery worker having succeeded in face authentication to a recipient of an undelivered package via the second terminal apparatus; and

a step of, if the recipient having received the notification by the notification step requests the delivery of the undelivered package by the delivery worker via the second terminal apparatus and face authentication of the recipient is successfully performed, permitting the undelivered package to be handed over to the delivery worker at a delivery station.

Furthermore, in order to achieve the above-described object, a computer readable recording medium according to an example aspect of the invention is a computer readable recording medium that includes recorded thereon a program for managing the delivery of packages using a computer,

the program including instructions that cause the computer to carry out:

a management step of managing the reliability of a package delivery worker;

a notification step of, if face authentication of the delivery worker is successfully performed via a first terminal apparatus used by the delivery worker, providing a notification of the reliability of the delivery worker having succeeded in face authentication to a recipient of a package via a second terminal apparatus used by the recipient; and

a permission step of, if the recipient having received the notification by the notification step requests the delivery of an undelivered package by the delivery worker via the second terminal apparatus and face authentication of the recipient is successfully performed, permitting the undelivered package to be handed over to the delivery worker at a delivery station.

### Advantageous Effects of the Invention

As described above, according to the invention, the shortage of delivery workers in delivery services can be overcome.

### BRIEF DESCRIPTION OF THE DRAWINGS

FIG. 1 is a block diagram illustrating a configuration of a delivery system in an example embodiment of the invention.

FIG. 2 is a block diagram illustrating the configuration of the delivery system in the example embodiment of the invention in detail.

FIG. 3 is a sequence diagram illustrating the first half of operations of the delivery system in the example embodiment of the invention.

FIG. 4 is a sequence diagram illustrating the second half of the operations of the delivery system in the example embodiment of the invention.

FIG. 5 is a block diagram illustrating one example of a computer for realizing a delivery management apparatus 40 in the example embodiment of the invention.

### EXAMPLE EMBODIMENT

### Example Embodiment 1

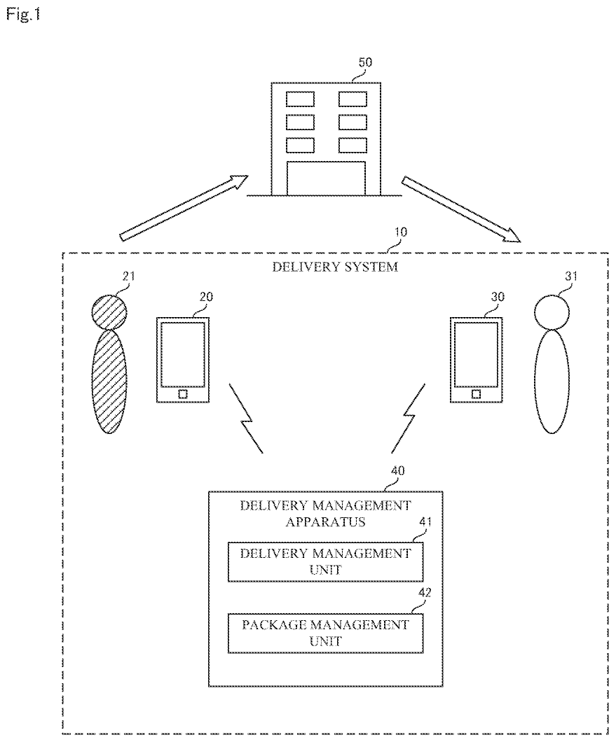

In the following, a delivery system, a delivery management apparatus, a terminal apparatus, a delivery method, and a program in an example embodiment of the invention will be described with reference to FIGS. 1 to 5.

[System Configuration]

First, a configuration of the delivery system in the example embodiment of the invention will be described with reference to FIG. 1. FIG. 1 is a block diagram illustrating a configuration of the delivery system in the example embodiment of the invention.

The delivery system in the present example embodiment illustrated in FIG. 1 is a system for realizing the delivery of packages by delivery workers. Furthermore, in the present example embodiment, it is considered that the delivery workers are delivery workers other than those belonging to delivery companies. Examples of delivery workers other than those belonging to delivery companies include ordinary people and subcontractors.

As illustrated in FIG. 1, a delivery system 10 in the present example embodiment includes a terminal apparatus 20 used by a package delivery worker 21 (hereinafter “delivery worker terminal”), a terminal apparatus 30 used by a package recipient 31 (hereinafter “recipient terminal”), and a delivery management apparatus 40.

Furthermore, as illustrated in FIG. 1, the delivery management apparatus 40 includes a delivery worker management unit 41 and a package management unit 42. The delivery worker management unit 41 manages the reliability of the delivery worker 21. The package management unit 42, if face authentication of the delivery worker 21 is successfully performed via the delivery worker terminal 20, first provides a notification of the reliability of the delivery worker 21 having succeeded in face authentication to a recipient 31 of an undelivered package via the recipient terminal 30.

Then, if the recipient 31 having received the notification requests the delivery of the undelivered package by the delivery worker 21 via the recipient terminal 30 and face authentication of the recipient 31 is successfully performed, the package management unit 42 permits the undelivered package to be handed over to the delivery worker 21 at a delivery station 50.

In such a manner, in the present example embodiment, a delivery worker 21 can deliver a package to the recipient 31 only if both the delivery worker 21 and the recipient 31 succeed in face authentication and the recipient 31 requests the delivery of the package by this delivery worker 21. Thus, the recipient 31 can reliably entrust the delivery of the package even if a delivery worker other than delivery workers belonging to delivery companies will be delivering the package as the delivery worker 21. As a result of this, according to the present example embodiment, the shortage of delivery workers in delivery services can be overcome.

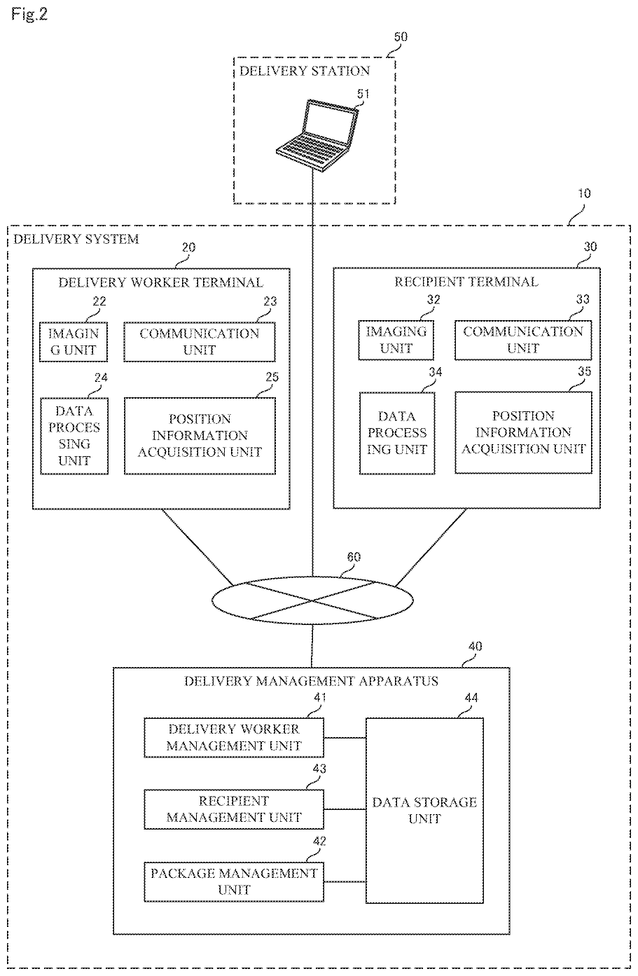

Next, the configuration of each of the delivery worker terminal 20, the recipient terminal 30, and the delivery management apparatus 40 constituting the delivery system 10 in the example embodiment of the invention will be described in detail with reference to FIG. 2. FIG. 2 is a block diagram illustrating the configuration of the delivery system in the example embodiment of the invention in detail.

First, in the present example embodiment, the delivery worker terminal 20, the recipient terminal 30, and the delivery management apparatus 40 constituting the delivery system 10 are connected via a network 60 such as the Internet, as illustrated in FIG. 2.

Furthermore, a terminal 51 installed in the delivery station 50 is also connected to the delivery system 10 via the network 60. Although not illustrated in the drawings, the terminal 51 also includes a face authentication camera.

Also, as illustrated in FIG. 2, the delivery worker terminal 20 includes an imaging unit 22, a communication unit 23, a data processing unit 24, and a position information acquisition unit 25. Among these units, the imaging unit 22 is a camera unit including a solid-state image sensor and a lens, and outputs image data of images that are taken.

The communication unit 23 is a communication device for performing data communication with external apparatuses. In response to instructions from the data processing unit 24, the communication unit 23 transmits data indicated by the instructions to the delivery management apparatus 40. Furthermore, when data is transmitted thereto from the delivery management apparatus 40, the communication unit 23 receives the data and outputs the received data to the data processing unit 24.

The position information acquisition unit 25 acquires position information specifying the position of the delivery worker terminal 20. For example, the position information acquisition unit 25 is a global positioning system (GPS) receiver. The GPS receiver, upon receiving signals from three of more GPS satellites, calculates the distance to each GPS satellite from a transmission time and a reception time. Furthermore, the GPS receiver acquires the position of itself from the position of and the distance to each GPS signal.

The data processing unit 24 executes data processing that is necessary for the delivery of packages by the delivery worker 21. For example, in response to instructions from the delivery management apparatus 40, the data processing unit 24 transmits information regarding the delivery worker 21, e.g., an identifier of the delivery worker 21 (hereinafter “delivery worker identifier (ID)”), to the delivery management apparatus 40. Also, if the delivery management apparatus 40 requests face authentication, the data processing unit 24 transmits image data of an image selected by the delivery worker 21 to the delivery management apparatus 40.

Furthermore, in response to instructions from the delivery management apparatus 40, the data processing unit 24 also transmits the position information acquired by the position information acquisition unit 25 to the delivery management apparatus 40. In addition, the data processing unit 24 displays data transmitted from the delivery management apparatus 40 on a screen of a display device (not illustrated) of the delivery worker terminal 20, as necessary.

Specific examples of the delivery worker terminal 20 include a smartphone, a tablet-type terminal, or the like. In such cases, the data processing unit 24 is constructed by an application program running on the operating system (OS) of the smartphone, tablet-type terminal, or the like.

Furthermore, as illustrated in FIG. 2, the recipient terminal 30 also includes an imaging unit 32, a communication unit 33, a data processing unit 34, and a position information acquisition unit 35. Among these units, the imaging unit 32, the communication unit 33, and the position information acquisition unit 35 are similar to the imaging unit 22, the communication unit 23, and the position information acquisition unit 25 in the above-described delivery worker terminal 20.

The data processing unit 34 executes data processing that is necessary for the receipt of packages by the recipient 31. For example, in response to instructions from the delivery management apparatus 40, the data processing unit 34 transmits information regarding the recipient 31, e.g., an identifier of the recipient 31 (hereinafter “recipient identifier (ID)”), to the delivery management apparatus 40. Also, if the delivery management apparatus 40 requests face authentication, the data processing unit 34 transmits image data of an image selected by the recipient 31 to the delivery management apparatus 40.

Furthermore, in response to instructions from the delivery management apparatus 40, the data processing unit 34 also transmits the position information acquired by the position information acquisition unit 35 to the delivery management apparatus 40. In addition, the data processing unit 34 displays data transmitted thereto from the delivery management apparatus 40 on a screen of a display device (not illustrated) of the recipient terminal 30, as necessary.

Specific examples of the recipient terminal 30 also include a smartphone, a tablet-type terminal, or the like. In such cases, the data processing unit 34 is also constructed by application software running on the operating system (OS) of the smartphone, tablet-type terminal, or the like.

Furthermore, as illustrated in FIG. 2, the delivery management apparatus 40 includes a recipient management unit 43 and a data storage unit 44 in addition to the delivery worker management unit 41 and the package management unit 42 illustrated in FIG. 1. The recipient management unit 43 manages the recipient's reliability. Details of the recipient management unit 43 will be described later.

The data storage unit 44 stores information regarding the delivery worker 21, e.g., the reliability of the delivery worker 21 and face information for face authentication of the delivery worker 21. In addition, the data storage unit 44 also stores information regarding the recipient 31, e.g., the reliability of the recipient 31 and face information for face authentication of the recipient 31. Face information for face authentication is information for specifying features of a face, and is extracted from an image of the face in advance.

In the present example embodiment, the package management unit 42 requests each of the delivery worker 21 and the recipient 31 to perform face authentication. When image data is transmitted thereto from the delivery worker terminal 20 or the recipient terminal 30, the package management unit 42 extracts features from the face image included in the image data, and collates the extracted features and the face information of the authentication-target individual stored in the data storage unit 44. Furthermore, the package management unit 42 determines that face authentication is successful if the extracted features and the face information match as a result of the collation, and otherwise determines that face authentication is unsuccessful.

Note that, in the present example embodiment, the data transmitted to the package management unit 42 from the delivery worker terminal 20 or the recipient terminal 30 need not be image data, and may be face information per se. Furthermore, if face authentication of the delivery worker 21 and the recipient 31 is successfully performed and the recipient 31 requests the delivery of an undelivered package by the delivery worker 21 via the recipient terminal 20, the package management unit 42 may transmit, to the delivery worker terminal 20, a notification permitting the undelivered package to be handed over to the delivery worker 21 at the delivery station 50.

Furthermore, in the present example embodiment, if face authentication of the recipient is successfully performed via the delivery worker terminal 20, the package management unit 42 can provide, to the delivery worker 21 via the delivery worker terminal 20, a notification that the package can be handed over to the recipient 31. Thus, a situation in which the delivery worker 21 erroneously delivers the package to a different person is avoided.

Furthermore, the package management unit 42 can acquire the position information of the recipient terminal 30 and transmit the acquired position information of the recipient terminal 30 to the delivery worker terminal 20. Also, the package management unit 42 can acquire the position information of the delivery worker terminal 20 and transmit the acquired position information of the delivery worker terminal 20 to the recipient terminal 30. Thus, the recipient 31 can receive the package outside the recipient's home, and delivery can be performed efficiently.

In the present example embodiment, if face authentication of the delivery worker 21 is successfully performed via the delivery worker terminal 20, the recipient management unit 43 provides a notification of list information in which undelivered packages are listed and the reliability of the recipient of each undelivered package to the delivery worker terminal 20. Subsequently, if one of the undelivered packages is selected on the delivery worker terminal 20 by the delivery worker 21 having succeeded in face authentication, the recipient management unit 43 provides a notification of the reliability of the delivery worker 21 having succeeded in face authentication to the recipient 31 of the selected undelivered package via the recipient terminal 30 of the recipient 31.

In such a manner, the recipient management unit 43 can notify both the delivery worker 21 and the recipient 31 of each other's reliability. Thus, the delivery worker 21 can safely deliver packages and the recipient 31 can safely request the delivery of packages.

In addition, in the present example embodiment, the delivery worker management unit 41, if receiving a notification of an evaluation of the delivery worker 21 from the recipient terminal 30, updates the reliability of the delivery worker 21 based on the evaluation of the delivery worker 21 in the notification. The updated reliability is stored to the data storage unit 44.

Furthermore, the recipient management unit 43, if receiving a notification of an evaluation of the recipient from the delivery worker terminal 20, updates the reliability of the recipient 31 based on the evaluation of the recipient 31 in the notification. In this case as well, the updated reliability is stored to the data storage unit 44.

Furthermore, in the present example embodiment, the update method and grading criteria of reliability are not particularly limited. For example, in the present example embodiment, reliability is set in ten grades, from “1” to “10”. In this case, reliability “5” is provided to delivery workers who have not delivered any packages using the delivery system 10 yet and recipients who have not received any packages using the delivery system 10 yet.

Furthermore, upon evaluation, the delivery worker 21 and the recipient 31 both add or subtract points to or from each other's reliability in accordance with the following criteria (1) to (5), for example.
(1) Delivery worker/recipient cancelled delivery or receipt immediately before (for example, one hour before, etc.) package delivery time: subtract 1 point
(2) Receipt of package completed within ±10 minutes from package delivery time: add 1 point
(3) Delivery worker/recipient arrived at delivery place of package20 minutes or more later than package delivery time: subtract 1 point
(4) Polite attitude of delivery worker/recipient: add 1 point
(5) Impolite attitude of delivery worker/recipient: subtract 1 point

[System Operations]

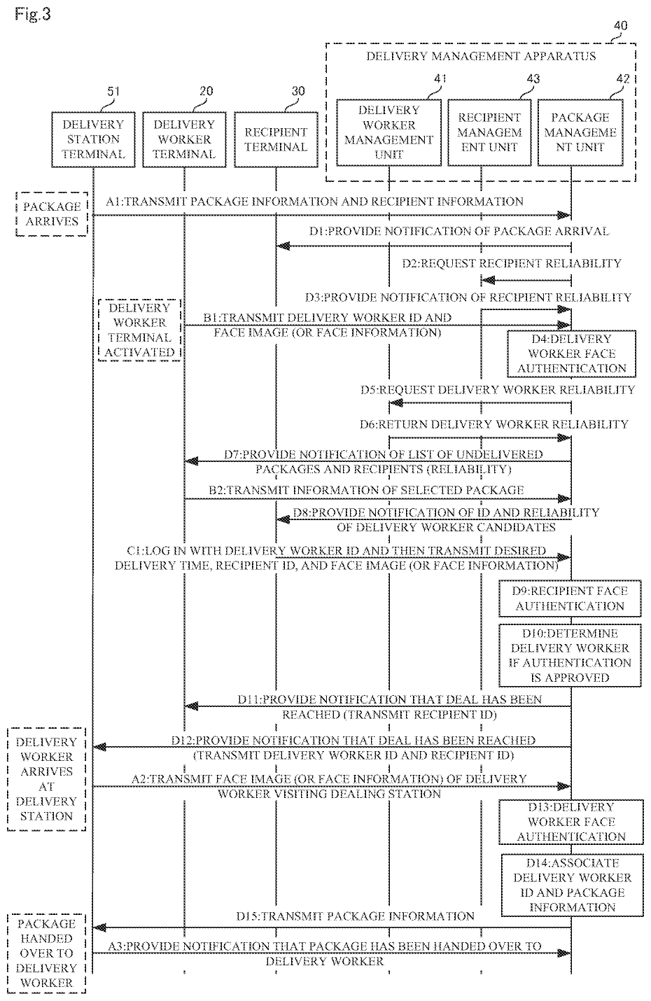

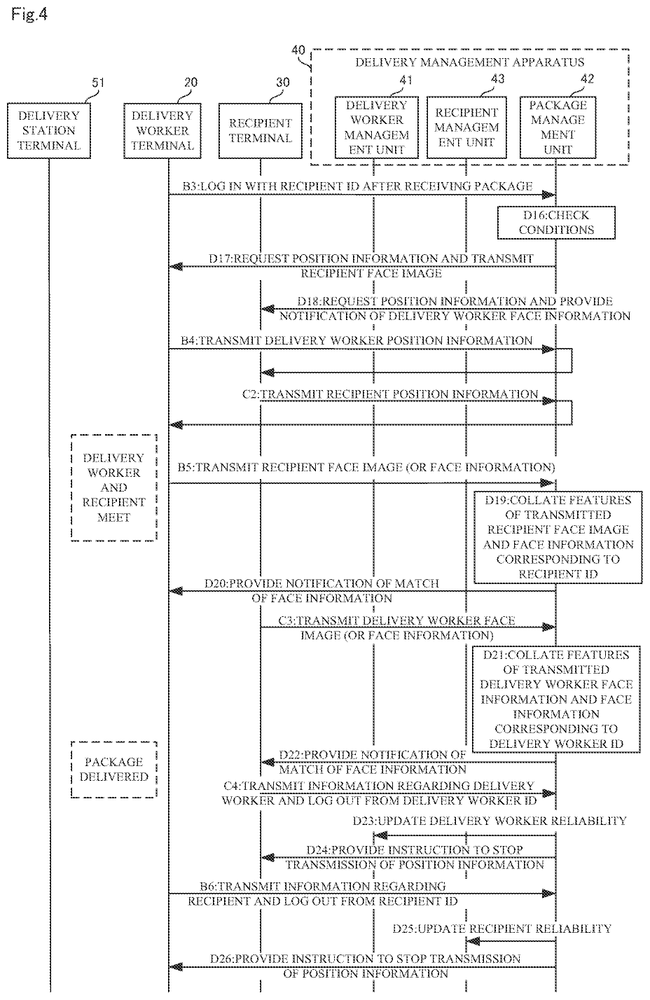

Next, operations of the delivery system 10 in the example embodiment of the invention will be described with reference to FIGS. 3 and 4. Furthermore, in the present example embodiment, a delivery method is implemented by causing the delivery system 10 to operate. Accordingly, the following description of the operations of the delivery system 10 is substituted for the description of the delivery method in the present example embodiment.

First, with reference to FIG. 3, the operations of the delivery system 10 from when a package arrives at a delivery station until when the package is entrusted to a delivery worker will be described. FIG. 3 is a sequence diagram illustrating the first half of the operations of the delivery system in the example embodiment of the invention. FIGS. 1 and 2 will be referred to as needed in the following description.

As illustrated in FIG. 3, first, when a package to be delivered arrives at the delivery station 50, a clerk performs input to that effect on the terminal 51. Accordingly, the terminal 51 transmits package information and recipient information to the delivery management apparatus 40 (step A1). Here, the transmitted package information is information including information specifying the sender and the recipient of the package, the desired delivery date/time, etc. Furthermore, the recipient information is information including the recipient's name and address, the desired delivery place, the recipient ID, etc.

Next, the package management unit 42 in the delivery management apparatus 40 specifies the recipient from the recipient information, and transmits, to the recipient terminal 30 of the specified recipient, a notification indicating that the package has arrived at a delivery station (package arrival) (step D1).

Next, after step D1 is executed, the package management unit 42 requests the reliability of the recipient 31 specified in step D1 from the recipient management unit 43 (step D2). Accordingly, the recipient management unit 43 provides a notification of the requested reliability to the package management unit 42 (step D3).

Furthermore, when a delivery worker 21 capable of delivery executes the application program and constructs the data processing unit 24 in the delivery worker terminal 20, the data processing unit 24 displays a message on the screen of the delivery worker terminal 20 to prompt the delivery worker 21 to take an image of his/her face. When the delivery worker 21 accordingly takes an image of his/her face using the imaging unit 22, the data processing unit 24 transmits the delivery worker ID and image data of the face image to the delivery management apparatus 40 via the communication unit 23 (step B1).

Note that in step B1, the data processing unit 24 may extract features from the image of the face that has been taken and create face information for face authentication. In this case, the data processing unit 24 transmits only the created face information.

When step B1 is executed, the package management unit 42 in the delivery management apparatus 40 executes face authentication using the transmitted delivery worker ID and the transmitted image data of the face image (step D4). Specifically, the package management unit 42 extracts face information stored in the data storage unit 44 using the transmitted delivery worker ID as a key, and collates features extracted from the image data with the extracted face information.

Then, if face authentication is successful as a result of step D4, the package management unit 42 requests the reliability of the delivery worker 21 having succeeded in face authentication from the delivery worker management unit 41 (step D5). Accordingly, the delivery worker management unit 41 provides a notification of the requested reliability to the package management unit 42 (step D6). Note that if face authentication is unsuccessful as a result of step D4, the package management unit 42 provides a notification that face authentication was unsuccessful to the delivery worker terminal 20, and terminates communication with this delivery worker terminal 20.

Next, after step D6 is executed, the package management unit 42 transmits a list of undelivered packages and the recipient of each package, along with the reliability of each recipient, to the delivery worker terminal 20 of the delivery worker 21 having succeeded in face authentication (step D7).

After step D7 is executed, the data processing unit 24 in the delivery worker terminal 20 displays the transmitted list on the screen of the delivery worker terminal 20. When the delivery worker 21 accordingly selects a specific package from the list, the data processing unit 24 transmits information regarding the package selected by the delivery worker 21 to the delivery management apparatus 40 via the communication unit 23 (step B2). Note that steps D7 and B2 are each performed a number of times corresponding to the number of delivery workers 21 having succeeded in face authentication.

Next, the package management unit 42 transmits the delivery worker ID and the reliability of delivery worker candidates to the recipient terminal 30 (step D8). Here, the delivery workers 21 who are designated as delivery worker candidates are the delivery workers 21 who selected the corresponding recipient 31 in step B2.

Next, after step D8 is executed, the data processing unit 34 in the recipient terminal 30 displays a list of delivery worker candidates and the reliability thereof on the screen of the recipient terminal 30. Then, when the recipient 31 selects a specific delivery worker 21 from the list and inputs a desired delivery time, the data processing unit 34 displays a message on the screen to prompt the recipient 31 to take a picture of his/her face.

Subsequently, the recipient 31 takes a picture of his/her face using the imaging unit 32. Accordingly, via the communication unit 33, the data processing unit 34 logs in to the delivery management apparatus 40 using the delivery worker ID of the selected delivery worker 21, and transmits the desired delivery time, the recipient ID, and image data of the face image to the delivery management apparatus 40 (step C1).

Note that in step C1, the data processing unit 34 may extract features from the image of the face that has been taken and create face information for face authentication. In this case, the data processing unit 34 transmits only the created face information.

When step C1 is executed, the package management unit 42 in the delivery management apparatus 40 executes face authentication using the transmitted recipient ID and the transmitted image data of the face image (step D9). Specifically, the package management unit 42 extracts face information stored in the data storage unit 44 using the transmitted recipient ID as a key, and collates features extracted from the image data with the extracted face information.

If face authentication is successful as a result of step D9, the package management unit 42 provides a notification that a deal has been reached to the delivery worker terminal 20, and also transmits the recipient ID to the delivery worker terminal 20 (step D11). Furthermore, in this case, the package management unit 42 also provides a notification that a deal has been reached to the terminal 51 in the delivery station 50 (step D12). In step D12, the package management unit 42 also provides a notification of the delivery worker ID and the recipient ID to the terminal 51 in the delivery station 50. Alternatively, the notification that a deal has been reached transmitted by the package management unit 42 may be a notification permitting the undelivered package to be handed over to the delivery worker 21 at the delivery station 50. Furthermore, the package management unit 42 may also provide a notification that a deal has been reached to the recipient terminal 30.

When step D12 is executed, the terminal 51 in the delivery station 50 displays a message on the screen thereof to prompt the clerk to take a face image of the delivery worker 21 visiting the delivery station 50. When the clerk accordingly takes a picture of the face of the delivery worker 21 using the terminal 51, the terminal 51 transmits image data of the face image that has been taken to the delivery management apparatus 40 (step A2).

Next, when step A2 is executed, the package management unit 42 in the delivery management apparatus 40 executes face authentication using the transmitted image data of the face image of the delivery worker (step D13). Step D13 is similar to above-described step D4.

If face authentication is successful as a result of step D13, the package management unit 42 associates the delivery worker's delivery worker ID and the package information of the package for which a deal was reached in step D11 (step D14). Next, the package management unit 42 transmits the package information associated with the delivery worker ID in step D1 to the terminal 51 in the delivery station 50 (step D15).

Subsequently, when the clerk hands over the package to the delivery worker 21 based on the package information and performs input to that effect on the terminal 51 in the delivery station 50, the terminal 51 provides a notification that the package has been handed over to the delivery worker 21 to the delivery management apparatus 40 (step A3).

Next, with reference to FIG. 4, the operations of the delivery system 10 from when a package is entrusted to a delivery worker until when delivery is completed will be described. FIG. 4 is a sequence diagram illustrating the second half of the operations of the delivery system in the example embodiment of the invention. FIGS. 1 and 2 will be referred to as needed in the following description.

First, after step D15 shown in FIG. 3 is executed, the delivery worker 21, upon receiving the package from the clerk in the delivery station, performs input to the effect that the package has been received on his/her delivery worker terminal 20. Accordingly, via the communication unit 23, the data processing unit 24 in the delivery worker terminal 20 logs in to the delivery management apparatus 40 using the recipient ID transmitted in step D11, as illustrated in FIG. 4 (step C1).

Next, the package management unit 42 in the delivery management apparatus 40 checks the delivery conditions such as the delivery place and delivery date/time of the package (step D16).

Next, the package management unit 42 requests position information specifying the position of the delivery worker terminal 20 from the delivery worker terminal 20, and transmits a face image of the recipient 31 to the delivery worker terminal 20 (step D17). The face image that is transmitted here may be the face image transmitted in step C1 or may be a face image registered in advance.

Subsequently, the package management unit 42 also requests position information specifying the position of the recipient terminal 30 from the recipient terminal 30, and also transmits a face image of the delivery worker 11 to the recipient terminal 30 (step D18). The face image that is transmitted here may be the face image transmitted in step B1 or may be a face image registered in advance.

When step D17 is executed, the data processing unit 24 in the delivery worker terminal 20 transmits the position information acquired by the position information acquisition unit 25 to the delivery management apparatus 40 via the communication unit 23 (step B4). Furthermore, the package management unit 42 in the delivery management apparatus 40 transmits as is to the recipient terminal 30 the transmitted position information of the delivery worker terminal 20.

Also, when step D18 is executed, the data processing unit 34 in the recipient terminal 30 transmits the position information acquired by the position information acquisition unit 35 to the delivery management apparatus 40 via the communication unit 33 (step C2). Furthermore, the package management unit 42 in the delivery management apparatus 40 transmits as is to the delivery worker terminal 20 the transmitted position information of the recipient terminal 30.

The above-described step B4 is repeatedly executed until later-described step D26 is executed. Also, the above-described step C2 is repeatedly executed until later-described step D24 is executed.

Then, the delivery worker 21 and the recipient 31 meet while checking each other's position information. Here, the positions specified by the position information of the delivery worker 21 and the position information of the recipient 31 substantially match. Accordingly, a message is displayed on the screen of the delivery worker terminal 20 to prompt the delivery worker 21 to take a face image of the recipient, and thus the delivery worker 21 takes an image of the face of the recipient 31 using his/her delivery worker terminal 20. Similarly, a message is also displayed on the screen of the recipient terminal 30 to prompt the recipient 31 to take a face image of the delivery worker, and thus the recipient 31 also takes an image of the face of the delivery worker 21 using his/her recipient terminal 30.

Next, the data processing unit 24 in the delivery worker terminal 20 transmits, to the delivery management apparatus 40 via the communication unit 23, image data of the recipient's face image that has been taken (step B5). In step B5 as well, the data processing unit 24 may extract features from the image of the face that has been taken and create face information for face authentication. In this case, the data processing unit 24 transmits only the created face information.

When step B5 is executed, the package management unit 42 in the delivery management apparatus 40 extracts features from the transmitted image data of the face image of the recipient 31, and collates the extracted features with face information extracted from the data storage unit 44 using the recipient ID as a key (step D19). Next, if the extracted features and the face information match as a result of the collation in step D19, the package management unit 42 provides a notification to that effect to the delivery worker terminal 20 (step D20).

If authentication of the recipient 31 is successful as a result of the collation in step D19, the package management unit 42 may provide, to the delivery worker 21 via the delivery worker terminal 20, a notification that the package can be handed over. Alternatively, if authentication of the recipient 31 is successful as a result of the collation in step D19 and authentication of the delivery worker 21 is successful as a result of the collation in later-described step D21, the package management unit 42 may provide, to the delivery worker 21 via the delivery worker terminal 20, a notification that the package can be handed over.

Furthermore, also in the recipient terminal 30, the data processing unit 34 transmits, to the delivery management apparatus 40 via the communication unit 23, image data of the delivery worker's face image that has been taken (step C3). In step C3 as well, the data processing unit 34 may extract features from the image of the face that has been taken and create face information for face authentication. In this case, the data processing unit 34 transmits only the created face information.

When step C3 is executed, the package management unit 42 in the delivery management apparatus 40 extracts features from the transmitted image data of the face image of the delivery worker 21, and collates the extracted features with face information extracted from the data storage unit 44 using the delivery worker ID as a key (step D21). Next, if the extracted features and the face information match as a result of the collation in step D21, the package management unit 42 provides a notification to that effect to the recipient terminal 30 (step D22).

If authentication of the delivery worker 21 is successful as a result of the collation in step D21, the package management unit 42 may provide, to the recipient 31 via the recipient terminal 30, a notification that the package can be received. Alternatively, if authentication of the delivery worker 21 is successful as a result of the collation in step D21 and authentication of the recipient 31 is successful as a result of the collation in earlier-described step D19, the package management unit 42 may provide, to the recipient 31 via the recipient terminal 30, a notification that the package can be received.

Once steps D20 and D22 are executed, the delivery worker 21 hands over the package to the recipient 31. Note that if the extracted features and the face information do not match as a result of the collation in both or one of steps D19 and D21, the package management unit 42 provides a notification that the delivery of the package should be cancelled to the delivery worker terminal 20 and the recipient terminal 30.

Upon receiving the package, the recipient 31 inputs information regarding the delivery worker 21 to his/her recipient terminal 30. The information regarding the delivery worker 21 is information for updating the reliability of the delivery worker 21, specifically, information regarding points added and subtracted in accordance with the above-described criteria (1) to (5). When the information regarding the delivery worker 21 is input, the data processing unit 34 in the recipient terminal 30, via the communication unit 33, transmits the information regarding the delivery worker 21 to the delivery management apparatus 40 and logs out from the delivery worker ID (step C4).

Next, when step C4 is executed, the package management unit 42 in the delivery management apparatus 40 inputs the transmitted information regarding the delivery worker to the delivery worker management unit 41 and causes the delivery worker management unit 41 to update the reliability of the delivery worker 21 (step D23). Furthermore, the package management unit 42 instructs the recipient terminal 30 to stop transmitting position information (step D24).

Also, upon handing over the package, the delivery worker 21 inputs information regarding the recipient 31 to his/her delivery worker terminal 20. The information regarding the recipient 31 is information for updating the reliability of the recipient 31. Specifically, the information regarding the recipient 31 also is information regarding points added and subtracted in accordance with the above-described criteria (1) to (5). When the information regarding the recipient 31 is input, the data processing unit 24 in the delivery worker terminal 20, via the communication unit 23, transmits the information regarding the recipient 31 to the delivery management apparatus 40 and logs out from the recipient ID (step B6).

Next, when step B6 is executed, the package management unit 42 in the delivery management apparatus 40 inputs the transmitted information regarding the recipient to the recipient management unit 43 and causes the recipient management unit 43 to update the reliability of the recipient 31 (step D25). Furthermore, the package management unit 42 instructs the delivery worker terminal 20 to stop transmitting position information (step D26).

[Effects of Embodiment]

In such a manner, according to present example embodiment 1, security is ensured in a case in which a delivery worker other than delivery workers belonging to delivery companies transports packages as the delivery worker 21, and thus the recipient 31 can reliably entrust the delivery of packages. As a result of this, according to the present example embodiment, the shortage of delivery workers in delivery services can be overcome.

Furthermore, in the present example embodiment, the delivery worker 21 and the recipient 31 can exchange position information with each other. Thus, according to the present example embodiment, the recipient 31 can receive packages at places he/she has selected, and thus efficient delivery is realized.

[Program]

It suffices for a program in the present example embodiment to be a program that causes a computer to carry out steps D1 to D15 illustrated in FIG. 3 and steps D16 to D26 illustrated in FIG. 4. By installing this program on a computer and executing the program, the delivery management apparatus 40 in the present example embodiment can be realized. In this case, the processor of the computer functions and performs processing as the delivery worker management unit 41, the package management unit 42, and the recipient management unit 43. Also, in the present example embodiment, the data storage unit 44 can be realized by storing data files constituting the above-described information in a storage device, such as a hard disk, included in the computer. Furthermore, the delivery method according to the present example embodiment is also realized by the delivery management apparatus 40 being realized.

Furthermore, the program in the present example embodiment may be executed by a computer system formed from a plurality of computers. In this case, the computers may each function as one of the delivery worker management unit 41, the package management unit 42, and the recipient management unit 43, for example. Furthermore, the data storage unit 44 may be constructed on a computer that is different from the computer that executes the program in the present example embodiment.

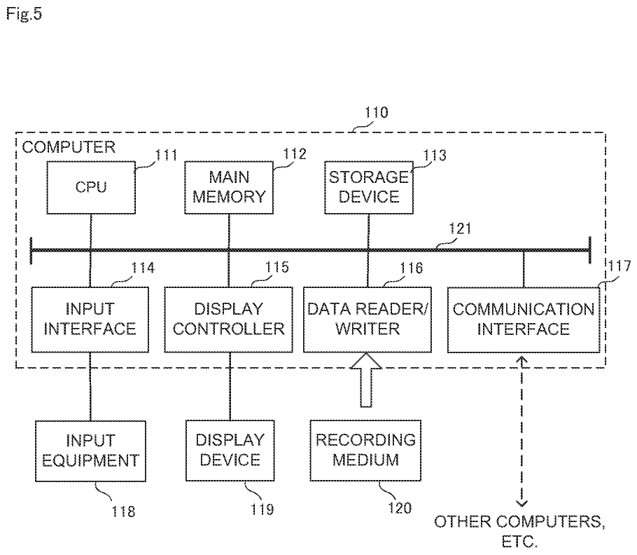

Here, a computer that realizes the delivery management apparatus 40 by executing the program in the present example embodiment will be described with reference to FIG. 5. FIG. 5 is a block diagram illustrating one example of a computer for realizing the delivery management apparatus 40 in the example embodiment of the invention.

As illustrated in FIG. 5, a computer 110 includes a central processing unit (CPU) 111, a main memory 112, a storage device 113, an input interface 114, a display controller 115, a data reader/writer 116, and a communication interface 117. These components are connected via a bus 121 so as to be capable of performing data communication with one another. Note that the computer 110 may include a graphics processing unit (GPU) or a field-programmable gate array (FPGA) in addition to the CPU 111 or in place of the CPU 111.

The CPU 111 loads the program (codes) in the present example embodiment, which is stored in the storage device 113, onto the main memory 112, and performs various computations by executing these codes in a predetermined order. The main memory 112 is typically a volatile storage device such as a dynamic random access memory (DRAM). Furthermore, the program in the present example embodiment is provided in a state such that the program is stored in a computer readable recording medium 120. Note that the program in the present example embodiment may also be a program that is distributed on the Internet, to which the computer 110 is connected via the communication interface 117.

In addition, specific examples of the storage device 113 include semiconductor storage devices such as a flash memory, in addition to hard disk drives. The input interface 114 mediates data transmission between the CPU 111 and input equipment 118 such as a keyboard and a mouse. The display controller 115 is connected to a display device 119, and controls the display performed by the display device 119.

The data reader/writer 116 mediates data transmission between the CPU 111 and the recording medium 120, and executes the reading out of the program from the recording medium 120 and the writing of results of processing in the computer 110 to the recording medium 120. The communication interface 117 mediates data transmission between the CPU 111 and other computers.

Furthermore, specific examples of the recording medium 120 include a general-purpose semiconductor storage device such as a CompactFlash (registered trademark, CF) card or a Secure Digital (SD) card, a magnetic recording medium such as a flexible disk, and an optical recording medium such as a compact disk read-only memory (CD-ROM).

Note that the delivery management apparatus 40 in the present example embodiment can also be realized by using pieces of hardware corresponding to the respective units, rather than using a computer on which the program is installed. Furthermore, a portion of the delivery management apparatus 40 may be realized by using a program, and the remaining portion of the delivery management apparatus 40 may be realized by using hardware.

While a part of or the entirety of the above-described example embodiment can be expressed by (Supplementary note 1) to (Supplementary note 29) described in the following, the invention is not limited to the following description.

(Supplementary Note 1)

A delivery system including a first terminal apparatus used by a package delivery worker, a second terminal apparatus used by a package recipient, and a delivery management apparatus, wherein

the delivery management apparatus includes:

a delivery worker management unit configured to manage the reliability of the delivery worker; and

a package management unit configured to: if face authentication of the delivery worker is successfully performed via the first terminal apparatus, provide a notification of the reliability of the delivery worker having succeeded in face authentication to a recipient of an undelivered package via the second terminal apparatus; and

if the recipient having received the notification requests the delivery of the undelivered package by the delivery worker via the second terminal apparatus and face authentication of the recipient is successfully performed, permit the undelivered package to be handed over to the delivery worker at a delivery station.

(Supplementary Note 2)

The delivery system according to Supplementary note 1, wherein

if face authentication of the recipient is successfully performed via the first terminal apparatus, the package management unit provides, to the delivery worker via the first terminal apparatus, a notification that the package can be handed over to the recipient.

(Supplementary Note 3)

The delivery system according to Supplementary note 1 or 2, wherein

the package management unit acquires position information of the second terminal apparatus, and transmits the acquired position information of the second terminal apparatus to the first terminal apparatus.

(Supplementary Note 4)

The delivery system according to any one of Supplementary notes 1 to 3, wherein

the package management unit acquires position information of the first terminal apparatus, and transmits the acquired position information of the first terminal apparatus to the second terminal apparatus.

(Supplementary Note 5)

The delivery system according to any one of Supplementary notes 1 to 4 further including a recipient management unit configured to manage the reliability of the recipient, wherein the package management unit:

if face authentication of the delivery worker is successfully performed via the first terminal apparatus, provides a notification of list information in which undelivered packages are listed and the reliability of the recipient of each undelivered package to the first terminal apparatus; and

if one of the undelivered packages is selected on the first terminal apparatus by the delivery worker having succeeded in face authentication, provides a notification of the reliability of the delivery worker having succeeded in face authentication to the recipient of the selected undelivered package via the second terminal apparatus.

(Supplementary Note 6)

The delivery system according to any one of Supplementary notes 1 to 5, wherein

the delivery worker management unit, if receiving a notification of an evaluation of the delivery worker from the second terminal apparatus, updates the reliability of the delivery worker based on the evaluation of the delivery worker in the notification.

(Supplementary Note 7)

The delivery system according to Supplementary note 5 or 6, wherein the recipient management unit, if receiving a notification of an evaluation of the recipient from the first terminal apparatus, updates the reliability of the recipient based on the evaluation of the recipient in the notification.

(Supplementary Note 8)

A delivery management apparatus that is an apparatus for managing the delivery of packages, including

a delivery worker management unit configured to manage the reliability of a package delivery worker; and

a package management unit configured to: if face authentication of the delivery worker is successfully performed via a first terminal apparatus used by the delivery worker, provide a notification of the reliability of the delivery worker having succeeded in face authentication to a recipient of an undelivered package via a second terminal apparatus used by the recipient; and

if the recipient having received the notification requests the delivery of the undelivered package by the delivery worker via the second terminal apparatus and face authentication of the recipient is successfully performed, permit the undelivered package to be handed over to the delivery worker at a delivery station.

(Supplementary Note 9)

The delivery management apparatus according to Supplementary note 8, wherein

if face authentication of the recipient is successfully performed via the first terminal apparatus, the package management unit provides, to the delivery worker via the first terminal apparatus, a notification that the package can be handed over to the recipient.

(Supplementary Note 10)

The delivery management apparatus according to Supplementary note 8 or 9, wherein

the package management unit acquires position information of the second terminal apparatus, and transmits the acquired position information of the second terminal apparatus to the first terminal apparatus.

(Supplementary Note 11)

The delivery management apparatus according to any one of Supplementary notes 8 to 10, wherein

the package management unit acquires position information of the first terminal apparatus, and transmits the acquired position information of the first terminal apparatus to the second terminal apparatus.

(Supplementary Note 12)

The delivery management apparatus according to any one of Supplementary notes 8 to 11 further including

a recipient management unit configured to manage the reliability of the recipient, wherein

the package management unit:

if face authentication of the delivery worker is successfully performed via the first terminal apparatus, provides a notification of list information in which undelivered packages are listed and the reliability of the recipient of each undelivered package to the first terminal apparatus; and

if one of the undelivered packages is selected on the first terminal apparatus by the delivery worker having succeeded in face authentication, provides a notification of the reliability of the delivery worker having succeeded in face authentication to the recipient of the selected undelivered package via the second terminal apparatus.

(Supplementary Note 13)

The delivery management apparatus according to any one of Supplementary notes 8 to 12, wherein

if a notification of an evaluation of the delivery worker is provided thereto from the second terminal apparatus, the delivery worker management unit updates the reliability of the delivery worker based on the evaluation of the delivery worker in the notification.

(Supplementary Note 14)

The delivery management apparatus according to Supplementary note 12 or 13, wherein

the recipient management unit, if receiving a notification of an evaluation of the recipient from the first terminal apparatus, updates the reliability of the recipient based on the evaluation of the recipient in the notification.

(Supplementary Note 15)

A terminal apparatus that performs data communication with a delivery management apparatus that manages the delivery of packages, the terminal apparatus including:

an imaging unit configured to take an image of a subject and output image data of the subject;

a position information acquisition unit configured to acquire position information of the terminal apparatus; and

a data processing unit, wherein

in response to instructions from the delivery management apparatus, the data processing unit transmits the image data output from the imaging unit and the position information acquired by the position information acquisition unit to the delivery management apparatus.

(Supplementary Note 16)

A delivery method in which a first terminal apparatus used by a package delivery worker, a second terminal apparatus used by a package recipient, and a delivery management apparatus are used, the delivery method including

the following steps carried out by the delivery management apparatus:

a management step of managing the reliability of the delivery worker;

a notification step of, if face authentication of the delivery worker is successfully performed via the first terminal apparatus, providing a notification of the reliability of the delivery worker having succeeded in face authentication to a recipient of an undelivered package via the second terminal apparatus; and

a permission step of, if the recipient having received the notification by the notification step requests the delivery of an undelivered package by the delivery worker via the second terminal apparatus and face authentication of the recipient is successfully performed, permitting the undelivered package to be handed over to the delivery worker at a delivery station.

(Supplementary Note 17)

The delivery method according to Supplementary note 16 further including

the following step carried out by the delivery management apparatus:

a second notification step of, if face authentication of the recipient is successfully performed via the first terminal apparatus, providing, to the delivery worker via the first terminal apparatus, a notification that the package can be handed over to the recipient.

(Supplementary Note 18)

The delivery method according to Supplementary note 16 or 17 further including

the following step carried out by the delivery management apparatus:

a first transmission step of acquiring position information of the second terminal apparatus and transmitting the acquired position information of the second terminal apparatus to the first terminal apparatus.

(Supplementary Note 19)

The delivery method according to any one of Supplementary notes 16 to 18 further including

the following step carried out by the delivery management apparatus:

a second transmission step of acquiring position information of the first terminal apparatus and transmitting the acquired position information of the first terminal apparatus to the second terminal apparatus.

(Supplementary Note 20)

The delivery method according to any one of Supplementary notes 16 to 19 further including

the following steps carried out by the delivery management apparatus:

a reliability management step of managing the reliability of the recipient;

a third notification step of, if face authentication of the delivery worker is successfully performed via the first terminal apparatus, providing a notification of list information in which undelivered packages are listed and the reliability of the recipient of each undelivered package to the first terminal apparatus; and

a fourth notification step of, if one of the undelivered packages is selected on the first terminal apparatus by the delivery worker having succeeded in face authentication, providing a notification of the reliability of the delivery worker having succeeded in face authentication to the recipient of the selected undelivered package via the second terminal apparatus.

(Supplementary Note 21)

The delivery method according to any one of Supplementary notes 17 to 20 further including

the following step carried out by the delivery management apparatus:

a first reliability updating step of, if a notification of an evaluation of the delivery worker is provided thereto from the second terminal apparatus, updating the reliability of the delivery worker based on the evaluation of the delivery worker in the notification.

(Supplementary Note 22)

The delivery method according to Supplementary note 20 or 21 further including

the following step carried out by the delivery management apparatus:

a second reliability updating step of, if a notification of an evaluation of the recipient is provided thereto from the first terminal apparatus, updating the reliability of the recipient based on the evaluation of the recipient in the notification.

(Supplementary Note 23)

A computer readable recording medium that includes recorded thereon a program for managing the delivery of packages using a computer,

the program including instructions that cause the computer to execute:

a management step of managing the reliability of a package delivery worker;

a notification step of, if face authentication of the delivery worker is successfully performed via a first terminal apparatus used by the delivery worker, providing a notification of the reliability of the delivery worker having succeeded in face authentication to a recipient of a package via a second terminal apparatus used by the recipient; and

a permission step of, if the recipient having received the notification by the notification step requests the delivery of an undelivered package by the delivery worker via the second terminal apparatus and face authentication of the recipient is successfully performed, permitting the undelivered package to be handed over to the delivery worker at a delivery station.

(Supplementary Note 24)

The computer readable recording medium according to Supplementary note 23, wherein

the program further includes instructions that cause the computer to execute:

a second notification step of, if face authentication of the recipient is successfully performed via the first terminal apparatus, providing, to the delivery worker via the first terminal apparatus, a notification that the package can be handed over to the recipient.

(Supplementary Note 25)

The computer readable recording medium according to Supplementary note 23 or 24, wherein

the program further includes instructions that cause the computer to execute:

a first transmission step of acquiring position information of the second terminal apparatus and transmitting the acquired position information of the second terminal apparatus to the first terminal apparatus.

(Supplementary Note 26)

The computer readable recording medium according to any one of Supplementary notes 23 to 25, wherein

the program further includes instructions that cause the computer to execute:

a second transmission step of acquiring position information of the first terminal apparatus and transmitting the acquired position information of the first terminal apparatus to the second terminal apparatus.

(Supplementary Note 27)

The computer readable recording medium according to any one of Supplementary notes 23 to 26, wherein

the program further includes instructions that cause the computer to execute:

a reliability management step of managing the reliability of the recipient;

a third notification step of, if face authentication of the delivery worker is successfully performed via the first terminal apparatus, providing a notification of list information in which undelivered packages are listed and the reliability of the recipient of each undelivered package to the first terminal apparatus; and

a fourth notification step of, if one of the undelivered packages is selected on the first terminal apparatus by the delivery worker having succeeded in face authentication, providing a notification of the reliability of the delivery worker having succeeded in face authentication to the recipient of the selected undelivered package via the second terminal apparatus.

(Supplementary Note 28)

The computer readable recording medium according to any one of Supplementary notes 24 to 27, wherein

the program further includes instructions that cause the computer to execute:

a first reliability updating step of, if a notification of an evaluation of the delivery worker is provided thereto from the second terminal apparatus, updating the reliability of the delivery worker based on the evaluation of the delivery worker in the notification.

(Supplementary Note 29)

The computer readable recording medium according to Supplementary note 27 or 28, wherein

the program further includes instructions that cause the computer to execute:

a second reliability updating step of, if a notification of an evaluation of the recipient is provided thereto from the first terminal apparatus, updating the reliability of the recipient based on the evaluation of the recipient in the notification.

The invention has been described with reference to an example embodiment above, but the invention is not limited to the above-described example embodiment. Within the scope of the invention, various changes that could be understood by a person skilled in the art could be applied to the configurations and details of the invention.

This application is based upon and claims the benefit of priority from Japanese application No. 2019-040051, filed on Mar. 5, 2019, the disclosure of which is incorporated herein in its entirety by reference.

### INDUSTRIAL APPLICABILITY

As described above, according to the invention, the shortage of delivery workers in delivery services can be overcome. The invention is useful in delivery service systems.

### REFERENCE SIGNS LIST

10 Delivery system

20 Delivery worker terminal

21 Delivery worker

22 Imaging unit

23 Communication unit

24 Data processing unit

25 Position information acquisition unit

30 Recipient terminal

31 Recipient

32 Imaging unit

33 Communication unit

34 Data processing unit

35 Position information acquisition unit

40 Delivery management apparatus

41 Delivery worker management unit

42 Package management unit

43 Recipient management unit

50 Delivery station

51 Terminal

60 Network

110 Computer

111 CPU

112 Main memory

113 Storage device

114 Input interface

115 Display controller

116 Data reader/writer

117 Communication interface

118 Input equipment

119 Display device

120 Recording medium

121 Bus

What is claimed is:

1. A delivery system comprising a first terminal apparatus used by a package delivery worker, a second terminal apparatus used by a package recipient, and a delivery management apparatus, wherein
the delivery management apparatus includes:
a delivery worker management unit configured to manage the reliability of the delivery worker; and
a package management unit configured to: if face authentication of the delivery worker is successfully performed via the first terminal apparatus, provide a notification of the reliability of the delivery worker having succeeded in face authentication to a recipient of an undelivered package via the second terminal apparatus; and
if the recipient having received the notification requests the delivery of the undelivered package by the delivery worker via the second terminal apparatus and face authentication of the recipient is successfully performed, permit the undelivered package to be handed over to the delivery worker at a delivery station.

2. A delivery management apparatus that is an apparatus for managing the delivery of packages, comprising:
a delivery worker management unit configured to manage the reliability of a package delivery worker; and
a package management unit configured to: if face authentication of the delivery worker is successfully performed via a first terminal apparatus used by the delivery worker, provide a notification of the reliability of the delivery worker having succeeded in face authentication to a recipient of an undelivered package via a second terminal apparatus used by the recipient; and
if the recipient having received the notification requests the delivery of the undelivered package by the delivery worker via the second terminal apparatus and face authentication of the recipient is successfully performed, permit the undelivered package to be handed over to the delivery worker at a delivery station.

3. The delivery management apparatus according to claim 2, wherein
if face authentication of the recipient is successfully performed via the first terminal apparatus, the package management unit provides, to the delivery worker via the first terminal apparatus, a notification that the package can be handed over to the recipient.

4. The delivery management apparatus according to claim 2, wherein
the package management unit acquires position information of the second terminal apparatus, and transmits the acquired position information of the second terminal apparatus to the first terminal apparatus.

5. The delivery management apparatus according to claim 2, wherein
the package management unit acquires position information of the first terminal apparatus, and transmits the acquired position information of the first terminal apparatus to the second terminal apparatus.

6. The delivery management apparatus according to claim 2 further comprising
a recipient management unit configured to manage the reliability of the recipient, wherein
the package management unit:
if face authentication of the delivery worker is successfully performed via the first terminal apparatus, provides a notification of list information in which undelivered packages are listed and the reliability of the recipient of each undelivered package to the first terminal apparatus; and
if one of the undelivered packages is selected on the first terminal apparatus by the delivery worker having succeeded in face authentication, provides a notification of the reliability of the delivery worker having succeeded in face authentication to the recipient of the selected undelivered package via the second terminal apparatus.

7. The delivery management apparatus according to claim 2, wherein
if a notification of an evaluation of the delivery worker is provided thereto from the second terminal apparatus, the delivery worker management unit updates the reliability of the delivery worker based on the evaluation of the delivery worker in the notification.

8. The delivery management apparatus according to claim 6, wherein
the recipient management unit, if receiving a notification of an evaluation of the recipient from the first terminal apparatus, updates the reliability of the recipient based on the evaluation of the recipient in the notification.

9. (canceled)

10. A non-transitory computer readable recording medium that includes recorded thereon a program for managing the delivery of packages using a computer,
the program including instructions that cause the computer to execute:
managing the reliability of a package delivery worker;
if face authentication of the delivery worker is successfully performed via a first terminal apparatus used by the delivery worker, providing a notification of the reliability of the delivery worker having succeeded in face authentication to a recipient of a package via a second terminal apparatus used by the recipient; and
if the recipient having received the notification requests the delivery of an undelivered package by the delivery worker via the second terminal apparatus and face authentication of the recipient is successfully performed, permitting the undelivered package to be handed over to the delivery worker at a delivery station.

11. The delivery system according to claim 1, wherein
if face authentication of the recipient is successfully performed via the first terminal apparatus, the package management unit provides, to the delivery worker via the first terminal apparatus, a notification that the package can be handed over to the recipient.

12. The delivery system according to claim 1, wherein
the package management unit acquires position information of the second terminal apparatus, and transmits the acquired position information of the second terminal apparatus to the first terminal apparatus.

13. The delivery system according to claim 1, wherein
the package management unit acquires position information of the first terminal apparatus, and transmits the acquired position information of the first terminal apparatus to the second terminal apparatus.

14. The delivery system according to claim 1 further including
a recipient management unit configured to manage the reliability of the recipient, wherein
the package management unit:
if face authentication of the delivery worker is successfully performed via the first terminal apparatus, provides a notification of list information in which undelivered packages are listed and the reliability of the recipient of each undelivered package to the first terminal apparatus; and
if one of the undelivered packages is selected on the first terminal apparatus by the delivery worker having succeeded in face authentication, provides a notification of the reliability of the delivery worker having succeeded in face authentication to the recipient of the selected undelivered package via the second terminal apparatus.

15. The delivery system according to claim 1, wherein
the delivery worker management unit, if receiving a notification of an evaluation of the delivery worker from the second terminal apparatus, updates the reliability of the delivery worker based on the evaluation of the delivery worker in the notification.

16. The delivery system according to claim 1, wherein
the recipient management unit, if receiving a notification of an evaluation of the recipient from the first terminal apparatus, updates the reliability of the recipient based on the evaluation of the recipient in the notification.
